(19) United States
(12) Patent Application Publication
(10) Pub. No.: US 2011/0202662 A1
(43) Pub. Date: Aug. 18, 2011

(54) NETWORK NODE FOR AN AD-HOC NETWORK AND PROCESS FOR PROVIDING APPLICATION SERVICES IN AN AD-HOC NETWORK

(75) Inventors: Oliver Nagy, Wien (AT); Refi-Tugrul Güner, Baden (AT); Erwin Toplak, Trumau (AT)

(73) Assignee: KAPSCH TRAFFICCOM AG, Wien (AT)

(21) Appl. No.: 13/027,095

(22) Filed: Feb. 14, 2011

(30) Foreign Application Priority Data
Feb. 18, 2010 (EP) 10450023.6
Nov. 9, 2010 (EP) 10450174.7

(51) Int. Cl. G06F 15/16

(52) U.S. Cl. 709/227

(57) ABSTRACT

A network node for an ad-hoc network having a plurality of network nodes of the same type, which provide one another with application services via wireless connections. The network node is configured to generate a list of all application services provided to it by other network nodes with associated quality classes and makes the list available to other network nodes as a list of the application services provided by it with such quality classes. At least one of the quality classes is dependent on movement vectors of at least one wireless connection, via which the respective application service is provided. The invention also relates to a method for providing application services in an ad-hoc network.

### CROSS-REFERENCE TO RELATED APPLICATION(S)

This application claims priority to European Patent Application Nos. 10 450 023.6, filed on Feb. 18, 2010 and 10 450 174.7, filed on Nov. 9, 2010, the contents of which are hereby expressly incorporated by reference.

### FIELD OF THE INVENTION

The present invention relates to a network node for an ad-hoc network having a plurality of network nodes of the same type, which provide one another with application services via wireless connections. The invention also relates to a process for providing application services in an ad-hoc network, the network nodes of which provide one another with application services via wireless connections.

### BACKGROUND

Wireless ad-hoc networks, i.e. networks that are formed from a group of peers (network nodes) spontaneously connecting to one another and are generally highly dynamic because of the movement and changeover of network nodes, are a research field in its infancy that is being increasingly applied and widespread. The present invention relates in particular to the application of ad-hoc network technologies for networking vehicles in so-called vehicular ad-hoc networks (VANETs).

Numerous routing algorithms have already been proposed for VANETs to find the best possible route for data packets from one network node to another network node. For example, patent document WO 03/034664 A1 describes the calculation of routing tables in the network nodes, which respectively list all routes via which a network node can access other network nodes with the same services. However, not all known routing algorithms for VANET network graph models are suitable for the provision of satisfactory network-wide application service switching for highly dynamic networks.

### SUMMARY

In some embodiments, the invention is a network node that is configured to generate a list of all application services provided to it by other network nodes. The list includes associated quality classes. The network node makes this list available to other network nodes as a list of the application services provided by it with such quality classes. At least one of the quality classes is dependent on movement vectors of at least one wireless connection, via which a respective application service is provided.

In some cases, the quality class is dependent on the movement vectors of the respective last wireless connection, which as a result of the recursive list formation of the other network nodes provides in each network node a complete application overview that takes into consideration the movement vectors of the entire network.

Optionally, the quality class can also depend on the bandwidth and/or latency of the last wireless connection in order to include further quality criteria.

According to some embodiments of the invention, the network node additionally contains a list of booked application services and matches the “local available service table” (LAST) list of application services provided by it with said booked application services and in the case of a match notifies an application in the network node. As a result, entry into specific service coverage regions can be detected and associated applications can be automatically launched.

The list of provided application services may also contain an access authorisation class for each application service, for example depending on associated cost or user group.

In a some embodiments, the present invention is a method for providing application services in an ad-hoc network, the network nodes of which provide one another with application services via wireless connections. The method includes: in one network node, creating a list of all application services provided to this network node by other network nodes with associated quality classes and making available this list for other network nodes as list of the application services provided by it with such quality classes. The method includes that at least one quality class is dependent on movement vectors of at least one wireless connection, via which the respective application service is provided.

### BRIEF DESCRIPTION OF THE DRAWINGS

FIG. 1 shows an overview of a vehicular ad-hoc network with network nodes, according to some embodiments of the present invention;

FIG. 2 shows a detail sectional view of the network of FIG. 1;

FIG. 3 shows an exemplary structure of a LAST list in a network node, according to some embodiments of the present invention; and

FIG. 4 is an exemplary schematic diagram of quality classes and their variation from a network node to another network node, according to some embodiments of the present invention.

### DETAILED DESCRIPTION

In some embodiments, the invention is a network node that is configured to generate a list of all application services provided to it by other network nodes. The list includes associated quality classes. In this way, in each network node a local application overview is generated in the form of the said list of all application services available to this network node with their respective service quality, which list is also referred to here as “local available service table” (LAST). In this case, the movement vectors of the partners (network nodes) of the respective wireless connection(s) are evaluated for assessment of the service quality. Thus, a wireless connection between network nodes, which are expected to only encounter one another briefly on the basis of their current movement vectors, can result in a lower quality class for application services provided in that regard than other less dynamic wireless connections, for example between two network nodes moving approximately equally quickly in the same direction. As a result, service overviews for highly dynamic and highly mobile network topographies can thus be generated locally in each network node.

According to some embodiments of the invention, the quality class is additionally dependent on the number of consecutive network nodes, via which the respective application service is provided, and the quality class specified by the last of these network nodes. Thus, the LAST list of a network node is composed—recursively as it were—of the LAST lists of the adjacent nodes receivable by this network node, which are in turn composed of the LAST lists of their adjacent network nodes, and so on. The LAST lists can therefore be generated locally and independently by each network node and still provide a complete overview of all application services currently available in the entire ad-hoc network without requiring a central distribution or survey mechanism or any specific routing algorithms.

The network node according to the invention is particularly suitable for vehicular ad-hoc networks (VANETs), in which case it is an onboard unit (OBU), such as currently used for example for wireless toll systems according to the DSRC, WAVE or GPS/GSM standard.

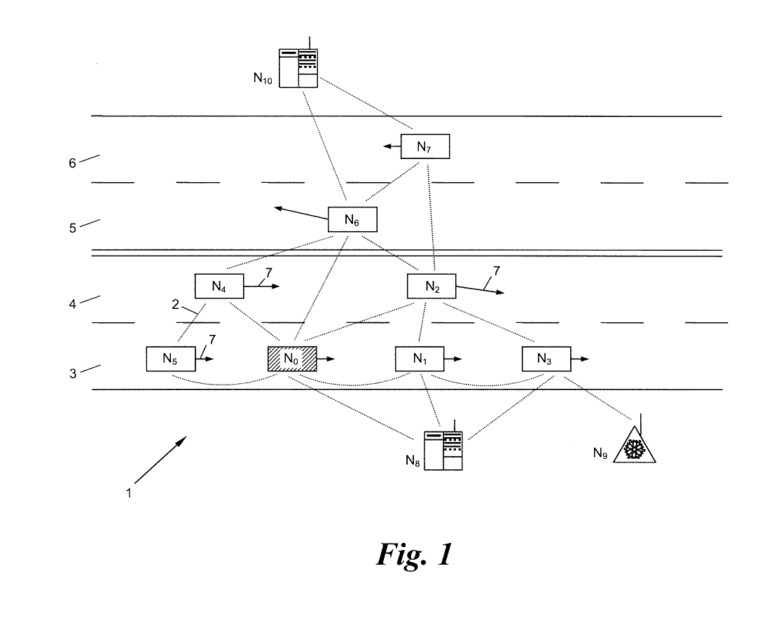

FIG. 1 shows a snapshot of an ad-hoc network 1 comprising a plurality (here eleven) of network nodes N₀, N₁, . . . N₁₀, which can communicate with one another via wireless connections 2. The wireless connections 2 generally have a limited range, and therefore one network node N₁ only communicates with closely adjacent network nodes, i.e. via a single wireless connection 2 (“single hop”), whereas it communicates indirectly with other network nodes, i.e. via multiple consecutive wireless connections 2 or intermediate network nodes N₁ (“multi-hop”).

The wireless connections 2 can be of any type known in the art, for example DSRC, mobile radio or WLAN connections, according to the wireless access in a vehicle environment (WAVE) standard.

In the shown example, some of the network nodes Nᵢ are onboard units (OBUs) that are carried by vehicles (see network nodes N₀-N₇), others are for example stationary network nodes such as an exemplary wireless toll station N₈ (toll beacon), an ice warning system N₉, or a wireless internet access point N₁₀. Any other desired types of network nodes N₁ are conceivable, for example wireless vending machines for entry tickets, parking tickets, city toll tickets or the like, communication terminals, traffic monitoring systems, mobile access points. etc.

The in-vehicle network nodes N₀-N₇ in the shown example are moving on a four-lane motorway with two lanes 3, 4 running in one direction of travel and two lanes 5, 6 running in the other direction of travel. The arrows 7 indicate the current speed vector (speed, direction) of the mobile OBU network nodes N₀-N₇.

The network nodes Nᵢ provide one another with application services Sₙ via the wireless connections 2. That is, both those directly originating in the respective provider network node (see for example the ice warning services S₁ of network node N₉), and those that are merely passed on from a network node, as is primarily the case with OBU network nodes N₀-N₇ are provided with application services Sₙ. In the same way, the application services Sₙ provided to one network node Nᵢ can be used by another network node, for example by a software application running on the network node Nᵢ, and can also be passed from other network nodes onto yet other network nodes again.

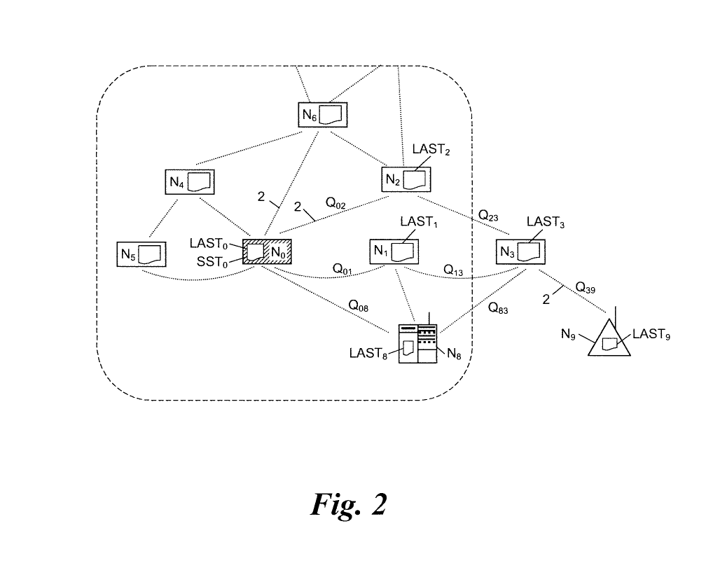

Each network node Nᵢ generates a list LASTᵢ of all application services Sₙ provided to it by other receivable network nodes Nᵢ (via wireless connections 2). The list LASTᵢ shall now be explained in more detail with reference to FIGS. 2-4.

FIG. 2 shows a simplified sectional view onto the ad-hoc network of FIG. 1, viewed from the network node N₀. Network node N₀, which generates its LAST list LAST₀ on the basis of the direct wireless connections 2 with its directly adjacent network nodes N₁, N₂, N₄, N₅, N₆ and N₈. The latter nodes themselves have respective lists LASTᵢ—generated from their local overview. In general terms, the lists LASTᵢ are respectively generated “recursively” from the lists of the receivable network nodes Nᵢ.

For each application service Sₙ available for the network node Nᵢ, each list LASTᵢ contains a quality class QECᵢₙ (quality estimate class) of the application service Sₙ. In some embodiments, the quality class QECᵢₙ includes the number of consecutive wireless connections 2 or network nodes Nᵢ, via which the application service Sₙ is provided (“hops”), and the quality class QECⱼₙ specified by the last network node Nⱼ in its list LASTⱼ. The quality class QECᵢₙ may further include the connection quality Qᵢⱼ of the last wireless connection 2, via which the application service Sₙ is provided to the network node Nᵢ by the last network node Nⱼ.

As an example, consider an “ice warning” service, which is provided by the network node N₉ in its list LAST₉ as service S₁ with, for example, the best quality class QEC₉₁ of “0” (representative of “zero hop”, high availability and high bandwidth) is classified in the list LAST₃ of the next network node N₃—after transmission via the wireless connection 2 with the connection quality Q₃₉—in the lower quality class QEC₃₁ of “1”, which for example stands for “single hop”, high availability and a slightly reduced bandwidth, as a result of for example a connection quality Q₃₉ of the wireless connection 2 of 90%.

The next network node N₁ on the propagation route towards the network node N₀ in turn builds its list LAST₁ on the LAST lists of the network nodes in the vicinity, including the LAST₃ list of the network node N₃, and once again calculates a quality class QEC₁₁ for the ice warning service S₁ with the consideration that there are now already two hops present, and with consideration of the connection quality Q₁₃ from network node N₃ to network node N₁. Similarly, the network node N₀ in turn generates its LAST₀ list from the data of the LAST₁ list, amongst other things, by incrementing the number of hops by 1, with consideration of the connection quality Q₀₁ and new classification of the service quality of the ice warning service S₁ in the quality class QEC₀₁ of for example “3”, representative of “triple hop”, high availability and a bandwidth of for example 60%.

If in one network node Nᵢ, for example network node N₀, the same ice warning service S₁ of network node N₉, can be switched via different paths in the ad-hoc network 1, for example here via N₉-N₃-N₂-N₀, N₉-N₃-N₁-N₀, N₉-N₃-N₈-N₀ etc., then these different possibilities can be included as different service entries Sₙ in the list LASTᵢ, respectively with the corresponding quality class QECᵢₙ. Alternatively, only the entry with the best quality class QECᵢₙ can be respectively stored in the list, which leads to an implicit best routing.

The connection quality Qᵢⱼ of a wire connection 2 can be dependent on a plurality of parameters, which a network node can preferably determine itself. The parameters include the bandwidth and/or the latency of the wireless connection 2 and/or the latency of the application service Sₙ, in case of a processing service, for example. In particular, the connection quality Qᵢⱼ also takes the movement vectors 7 of the partners of the respective wireless connection 2 into consideration. Therefore, network nodes that are expected to only encounter one another briefly on the basis of their vectors 7 (see for example the network node N₆ approaching network node N₄ or the network node N₄ overtaking network node N₅ in FIG. 1) result in a lower quality class for application services provided in that regard than other less dynamic wireless connections 2 (for example between two network nodes moving approximately equally quickly in the same direction).

The following Table 1 shows some examples of quality classes QEC, which can be defined on the basis of the number, bandwidth, latency and/or direction vectors of the wireless connections or participating network nodes and/or the availability class of the service provider.

TABLE 1

| | |
|---|---|
| QEC = 1 | Single hop, probable availability 100% |
| QEC = 2 | Single hop, probable availability 90% |
| | (for example 100 kbit/s for 30 seconds) |
| QEC = 3 | Triple hop, probable availability 80% |
| QEC = 4 | Double hop, probable availability 60% |

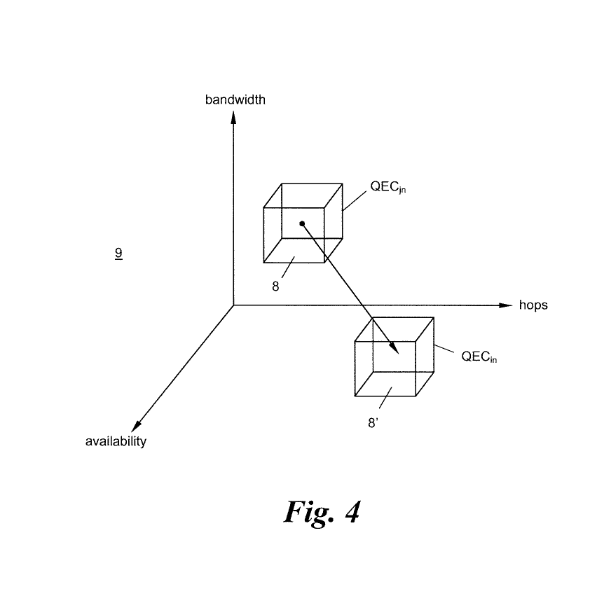

FIG. 4 is an exemplary schematic diagram of quality classes and their variation from a network node to another network node, according to some embodiments of the present invention. As shown in FIG. 4, the quality class QECᵢₙ or QECⱼₙ of an application service Sₙ in the list LASTᵢ of a network node Nᵢ or Nⱼ can also be seen as a restricted region 8 or 8′ in a multidimensional space 9, which the individual parameters such as hops, bandwidth, availability etc. cover. Variations in one or more of these parameters (occurred when an application service Sₙ is passed on from one network node Nⱼ to another network node Nᵢ) can thus lead to classification in the list LASTᵢ of the next network node Nᵢ in a different region 8′ from a previous region (8). Therefore, a different quality class QECᵢₙ from previously (QECⱼₙ) can result.

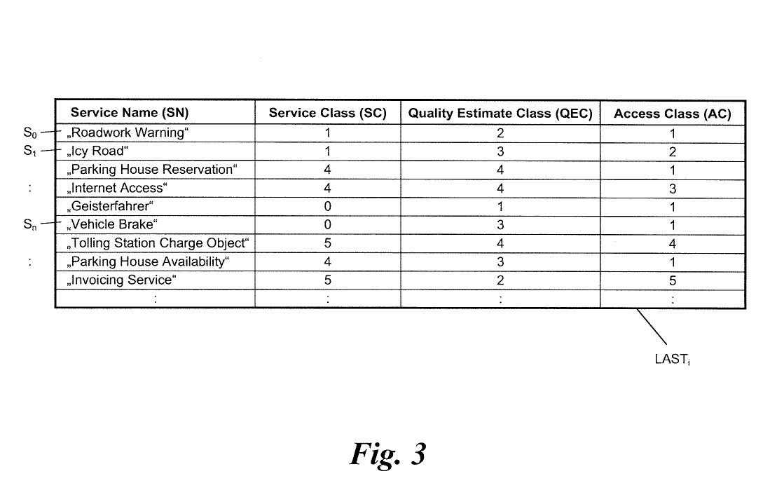

In addition to the quality class QEC, the list LASTᵢ can also contain a service class SC for each application service Sₙ, as shown in FIG. 3 and the following Table 2.

TABLE 2

| | |
|---|---|
| SID = 0 | Safety alert service vehicle |
| SID = 1 | Safety alert service infrastructure |
| SID = 2 | Sensor service vehicle |
| SID = 3 | Sensor service infrastructure |
| SID = 4 | Service point |
| SID = 5 | Infrastructure charging point service |
| SID = 6 | Infrastructure tolling info point service |

The service class SC can be used, for example, by network node Nᵢ or its applications in order to book (e.g., enroll or reserve) application services Sₙ of a specific service class SC. A software application on a network node Nᵢ can thus be notified automatically, for example, if an application service Sₙ of a specific service class SC is available. Specific application services Sₙ can, of course, also be booked directly in a network node Nᵢ on the basis of their name (service name, SN).

The list LASTᵢ can also contain an access authorisation class AC for each application service Sₙ, as shown in FIG. 3 and the following Table 3.

TABLE 3

| | |
|---|---|
| AC = 1 | Free access for all |
| AC = 2 | Safety subscriber, certificate required, flat fee |
| AC = 3 | Convenience subscriber, certificate required |
| AC = 4 | Tolling service provider, certificate required |
| AC = 5 | Roadside warning service provider, no certificate |

The access class AC can be applied by network nodes Nᵢ or their software applications to match the access authorisation to a specific application service.

In some embodiments, a network-wide certificate system utilizes the application services Sₙ made available to a network node Nᵢ. Accordingly, the network nodes Nᵢ—or the applications running on them—can identify themselves to the application services Sₙ utilised by means of appropriate public/private key certificates, for example, as is known in the art. It is also possible in this case to use time-restricted certificates so that application service requests, which are transmitted to application service providers from network nodes with time-restricted certificates, can be authenticated and implemented in a time-controlled and/or time-checked manner.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope and spirit of the invention as defined by the appended claims.

What is claimed is:

1. A network node for an ad-hoc network having a plurality of network nodes of the same type providing one another with application services via wireless connections, wherein the network node is configured to generate a list of all application services provided thereto by other network nodes and including associated quality classes, and to make said list available to other network nodes as a list of the application services provided by said network node including said quality classes, and wherein at least one of said quality classes is dependent on movement vectors of at least one wireless connection, via which a respective application service is provided.

2. The network node according to claim 1, wherein the at least one quality class is additionally dependent on a number of consecutive network nodes, via which the respective application service is provided, and a quality class specified by the last of the consecutive network nodes.

3. The network node according to claim 2, wherein the at least one quality class is dependent on movement vectors of the last wireless connection, via which the respective application service is provided.

4. The network node according to claim 1, wherein the quality class is additionally dependent on one or more of a bandwidth and a latency of the last wireless connection, via which the respective application service is provided.

5. The network node according to claim 1, further comprising a list of booked application services, wherein the network node is further configured to match said list of provided application services with said booked application services and in the case of a match, to notify an application in the network node.

6. The network node according to claim 1, wherein said list of provided application services also includes an access authorisation class for each application service.

7. The network node according to claim 1, wherein the network node is an onboard unit.

8. A method for providing application services in an ad-hoc network including a plurality of network nodes that provide one another with application services via wireless connections, the method comprising:
in one of the plurality of network nodes, creating a list of all application services provided to said one network node by other network nodes, the list including associated quality classes; and
making available said list for the other network nodes as a list of the application services provided by said one network node with said quality classes, wherein
at least one of said quality classes is dependent on movement vectors of at least one wireless connection, via which a respective application service is provided.

9. The method according to claim 8, wherein the least one quality class is additionally dependent on a number of consecutive network nodes, via which the respective application service is provided, and a quality class specified by the last of the consecutive network nodes.

10. A method according to claim 8, wherein the least one quality class is additionally dependent on one or more of a bandwidth and a latency of the last wireless connection, via which the respective application service is provided.
